(19) United States
(12) Patent Application Publication
(10) Pub. No.: US 2022/0396354 A1
(43) Pub. Date: Dec. 15, 2022

(54) PATIENT TRANSFER DEVICE

(71) Applicants: ULSAN NATIONAL INSTITUTE OF SCIENCE AND TECHNOLOGY, Ulsan (KR); DRONEDOM CO., LTD., Seongnam-si (KR)

(72) Inventors: Yunwoo JEONG, Seoul (KR); Sungbin SEO, Yangpyeong-gun (KR)

(73) Assignees: ULSAN NATIONAL INSTITUTE OF SCIENCE AND TECHNOLOGY, Ulsan (KR); DRONEDOM CO., LTD., Seongnam-si (KR)

(21) Appl. No.: 17/773,684

(22) PCT Filed: Oct. 27, 2020
(86) PCT No.: PCT/KR2020/014749

§ 371 Date: May 2, 2022

(30) Foreign Application Priority Data
Nov. 5, 2019 (KR) 10-2019-0140313

(51) Int. Cl. B64C 27/52; B64C 27/20; A61G 1/04

(52) U.S. Cl. CPC B64C 27/52; B64C 27/20; A61G 1/04

(57) ABSTRACT

A patient transfer device. According to one embodiment, there is provided a patient transfer device: a support part including a patient seating surface on which a patient is supported; a plurality of propeller parts, connected to the support part, for moving the support part; a power supply unit to be transported while being borne by the user, the power supply unit serving to supply power to the plurality of propeller parts; and a connection member connecting the power supply unit and the support part, wherein the support part is configured to move to follow the power supply unit.

### TECHNICAL FIELD

The present disclosure relates to a patient transfer device.

### BACKGROUND

In general, when an emergency patient occurs due to an accident such as a traffic accident or personal injury caused by a fire, it is necessary to quickly transport the emergency patient from the accident site to a hospital. In a typical method of transporting an emergency patient, an ambulance is used to transport the emergency patient from an accident site to a hospital, and during the transport, emergency measures may be performed or necessary treatment such as surgery may be performed inside the ambulance.

Meanwhile, in order to transport an emergency patient to a hospital through an ambulance, a rescue worker seats or lays the patient on a stretcher, then lift the stretcher and transfer the patient to the ambulance from an accident place. However, in case that an accident has taken place at a location that an ambulance cannot reach, such as a fire in a high-rise building or a personal injury during hiking, it takes a long time to transfer an emergency patient to the ambulance.

In addition, as for a general rescue stretcher, two rescue workers lift the stretcher at both sides to transfer a patient. In the case of transferring a child who weighs less, the number of rescue workers does not matter, but in the case of transferring an adult who weighs a lot, two or more rescue workers may be needed and it may take a longer time.

Accordingly, there is a need for a device capable of quickly transferring a patient from an accident place that an ambulance cannot reach to the ambulance with a less number of workers.

### SUMMARY

Embodiments of the present disclosure are conceived in view of the above, and the present disclosure provides a patient transfer device capable of quickly transferring a patient from an accident place that an ambulance cannot reach to the ambulance with a less number of workers.

In accordance with an aspect of the present disclosure, there is provided a patient transfer device including: a support part including a patient seating surface on which a patient is supported; a plurality of propeller parts, connected to the support part, for moving the support part; a power supply unit to be transported while being borne by the user, the power supply unit serving to supply power to the plurality of propeller parts; and a connection member connecting the power supply unit and the support part, wherein the support part is configured to move to follow the power supply unit.

The patient transfer device may further include: a plurality of folding parts each of which has one end rotatably connected to each of the propeller parts, and the other end rotatably connected to the support part, wherein the folding parts rotate relative to the support part to fold the plurality of propeller parts toward the support part.

The plurality of propeller parts may be supported by the support part such that one of the plurality of propeller parts is symmetrical with another one of the plurality of propeller parts with respect to a center of the support part.

The patient transfer device may further include: a control unit configured to control driving of the plurality of propeller parts; and a tilt detector which detects tilting of the support part, generates tilting information, and transmits the tilting information to the control unit, wherein when one side of the support part is tilted, based on the tilting information, the control unit performs a horizontal level maintenance control by controlling a rotation of the propeller part disposed closest to the one side of the support part among the plurality of propeller parts so that the patient seating surface of the support part is perpendicular to a direction of gravity.

The patient transfer device may further include: a tracking signal generator which generates a tracking signal; and a control unit configured to control driving of the plurality of propeller parts, wherein the support part includes a sensor unit which generates a moving signal by detecting the tracking signal generated by the tracking signal generator, and the control unit controls the driving of the plurality of propeller parts so that the support part moves toward the tracking signal generator based on the moving signal generated by the sensor unit.

When a position of the tracking signal generated from the tracking signal generator changes in a left or right direction, the control unit may control the driving of the plurality of propeller parts so that the support part moves in the left or right direction along the tracking signal after moving a predetermined distance.

When a position of the tracking signal generated from the tracking signal generator changes in an upward or downward direction while moving, the control unit may control the driving of the plurality of propeller parts so that the support part moves upward or downward along the tracking signal while maintaining a horizontal level after moving a predetermined distance.

The tracking signal generator may be provided in one of the user and the power supply unit borne by the user.

According to the embodiments of the present disclosure, it is possible to quickly transfer a patient from an accident place that an ambulance cannot reach to the ambulance with a less number of workers.

### BRIEF DESCRIPTION OF THE DRAWINGS

FIG. 1 is a perspective view of a patient transfer device according to one embodiment of the present disclosure.

FIG. 2 is a plan view of a support part and a propeller part when the propeller part of FIG. 1 is unfolded.

FIGS. 3A to 3D are views illustrating an order in which the propeller part of FIG. 1 is unfolded.

FIG. 4 is an enlarged view illustrating a state in which a battery is mounted to a power supply unit of FIG. 1.

FIG. 5 is a diagram illustrating a state in which a rescue worker transfers a patient using the patient transfer device according to one embodiment of the present disclosure.

FIG. 6 is a diagram illustrating a state in which a rescue worker transfers a patient using a patient transfer device according to another embodiment of the present disclosure.

### DETAILED DESCRIPTION

Hereinafter, specific embodiments for implementing a spirit of the present disclosure will be described in detail with reference to the drawings.

In describing the present disclosure, detailed descriptions of known configurations or functions may be omitted to clarify the present disclosure.

When an element is referred to as being ‘connected’ to, ‘supported’ by, ‘supplied’ to, or ‘detached’ from another element, it should be understood that the element may be directly connected to, supported by, supplied to, or detached from another element, but that other elements may exist in the middle.

The terms used in the present disclosure are only used for describing specific embodiments, and are not intended to limit the present disclosure. Singular expressions include plural expressions unless the context clearly indicates otherwise.

Terms including ordinal numbers, such as first and second, may be used for describing various elements, but the corresponding elements are not limited by these terms. These terms are only used for the purpose of distinguishing one element from another element.

In the present specification, it is to be understood that the terms such as “including” are intended to indicate the existence of the certain features, areas, integers, steps, actions, elements, combinations, and/or groups thereof disclosed in the specification, and are not intended to preclude the possibility that one or more other certain features, areas, integers, steps, actions, elements, combinations, and/or groups thereof may exist or may be added.

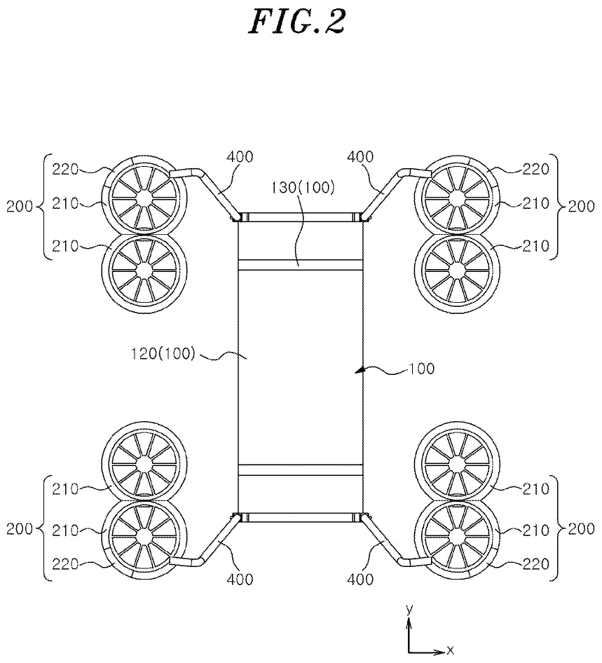

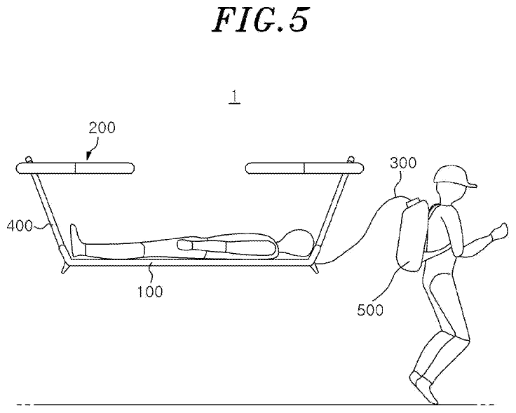

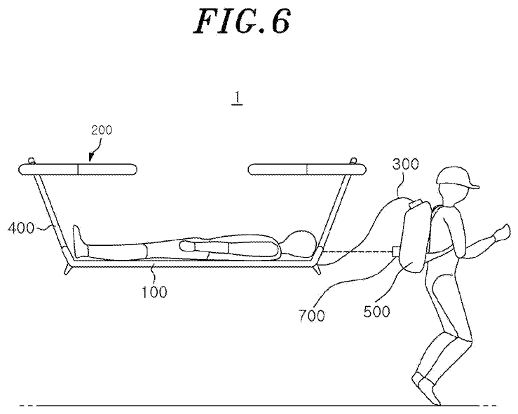

Further, in the present disclosure, it is to be noted that expressions, such as horizontal, vertical, upper side, lower side, left side, and right side are described based on the illustration of drawings, but may be modified if directions of corresponding objects are changed. In the present specification, the horizontal direction (left and right direction) may be the x-axis of FIG. 2, and the vertical direction may be the y-axis direction of FIG. 2. In addition, the upper and lower sides may be the upper and lower sides of FIG. 5.

Hereinafter, a specific configuration of a patient transfer device 1 according to one embodiment of the present disclosure will be described with reference to the drawings.

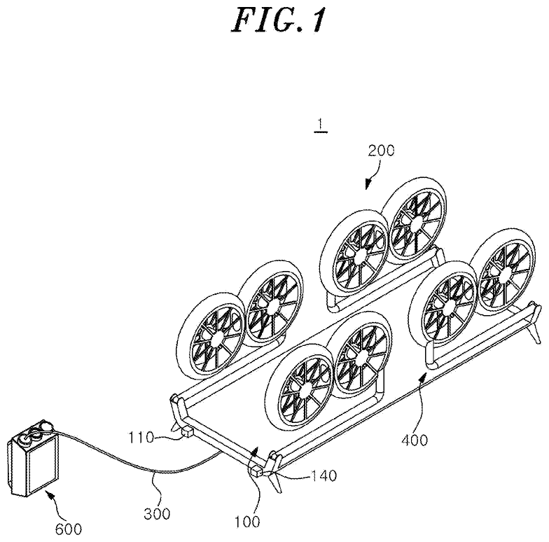

Hereinafter, referring to FIGS. 1 to 5, the patient transfer device 1 according to one embodiment of the present disclosure may be used to transfer a patient. When an emergency patient occurs at a place where an ambulance cannot reach, the patient transfer device 1 may be used by a rescue worker (user) to quickly move the patient to the ambulance. In addition, the movement of the patient transfer device 1 may be guided by the rescue worker, and the patient transfer device 1 may be moved up and down with respect to the ground autonomously. For example, the patient transfer device 1 may be an unmanned moving unit such as a drone. The patient transfer device 1 may include a support part 100, a propeller part 200, a connection member 300, a folding part 400, a power supply unit 500, and a control unit 600.

The support part 100 may support a patient. In other words, the support part 100 may include a patient seating surface 120 on which the patient can sit or lie down. In addition, the support part 100 may support the propeller part 200 and the folding part 400 which will be described later. The support part 100 can be moved up and down by the propeller part 200, and can support the patient in a state that it is floated from the ground. The support part 100 may be provided with a belt 130 capable of preventing the patient from falling out of the support part 100. The belt 130 may be provided at one surface of the support part 100, and a plurality of belts 130 may be provided. In a state that the support part 100 is moved up with respect to the ground by the propeller part 200, the support part 100 may move along the power supply unit 500 carried by the user. In addition, the movement of the support part 100 may be guided by the connection member 300. In other words, the support part 100 moves along the power supply unit 500 carried by the user, and the movement direction of the support part 100 may be determined by the connection member 300. In addition, the support part 100 may be provided with a tilt detector 140 capable of detecting whether the support part 100 is horizontal with respect to the ground.

The tilt detector 140 may generate information about tilting of the support part 100 in order to prevent the patient from falling out of the support part 100. In this case, the information about the tilting may be information on tilting of the support part 100 with respect to the ground, and information on whether the patient supported by the support part 100 is tilted while being moved. For example, the tilt detector 140 may include at least one of a horizontal sensor, a tilt sensor, and a distance sensor. The tilt detector 140 may generate information about the tilt of the support part 100 with respect to the ground, convert it into a tilt signal, and then transmit the tilt signal to the control unit 600.

Referring to FIG. 2, the propeller part 200 may move up or down with respect to the ground by rotation, thereby lifting or lowering the support part 100 and the folding part 400. Further, the propeller part 200 may be rotatably connected to the folding part 400. The rotation of the propeller part 200 may be controlled by the control unit 600.

Meanwhile, the propeller part 200 may include a plurality of propeller parts 200, and the plurality of propeller parts 200 may be supported by the support part 100 such that any one of the propeller parts 200 is symmetrical to another one of the propeller parts 200 with respect to the center of the support part 100. In other words, referring to FIG. 2, one of the plurality of propeller parts 200 may be connected to the folding part 400 to be symmetrical to another one of the plurality of propeller parts 200 with respect to a horizontal axis (x-axis in FIG. 2) and a vertical axis (y-axis in FIG. 2) passing through the center of the support part 100. In this way, since the plurality of propeller parts 200 are symmetrical to each other, the support part 100 may move more stably in a state that it is lifted from the ground. The propeller part 200 may include a propeller unit 210 and a light member 220.

The propeller unit 210 may move up or down with respect to the ground by rotation to lift or lower the support part 100 and the folding part 400. The propeller unit 210 may include a plurality of propeller units 210, and the plurality of propeller units 210 may be connected to each other to form the propeller part 200.

The light member 220 may emit light to indicate to the outside that a patient is being transferred. By the light emitted from the light member 220, people can recognize that a patient is being urgently transferred, and clear the path through which the patient is transferred. The light member 220 may be disposed in any one of the plurality of propeller units 210. In addition, the patient transfer device 1 may further include a sound device, and may sound an alarm to notify the surroundings that a patient is urgently being transferred.

The connection member 300 may transmit power to the propeller part 200 from the power supply unit 500 to be described later. In addition, the connection member 300 may connect the support part 100 and the power supply unit 500. One end of the connection member 300 may be connected to the power supply unit 500, and the other end of the connection member 300 may be connected to the support part 100. The connection member 300 may guide the movement of the support part 100 along the movement of the power supply unit 500. In other words, the connection member 300 may move along a movement direction of a rescue worker who bears the power supply unit 500 and provide a movement direction to the support part 100.

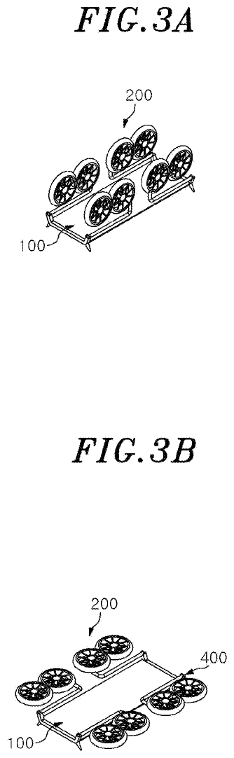

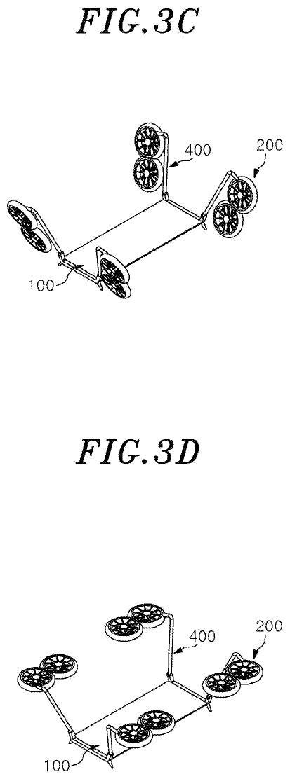

Referring to FIGS. 3A and 3B, the folding part 400 may rotate with respect to the support part 100 to fold the propeller part 200 toward the support part 100. One end of the folding part 400 may be rotatably connected to the propeller part 200 to support the propeller part 200. In addition, the other end of the folding part 400 may be rotatably connected to the support part 100. A plurality of folding parts 400 may be provided to be connected to the plurality of propeller parts 200.

The power supply unit 500 may supply power to the propeller part 200 to drive the propeller part 200. The power supply unit 500 may be connected to the support part 100 through the connection member 300, and may supply power to the propeller part 200. In addition, the power supply unit 500 may be borne by a rescue worker, and may be carried while being borne by the rescue worker. The power supply unit 500 may include a supply body 510, a battery 520, a display 530, a button 540, and a supply cover 550.

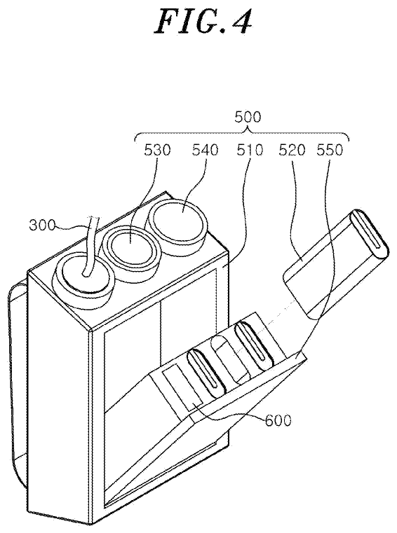

Referring to FIG. 4, the supply body 510 may provide a space in which the battery 520, the display 530 and the button 540 to be described later are accommodated. As for the supply body 510, the supply cover 550 hinged to the supply body 510 is rotated to an open position by the button 540, so that the interior of the supply body 510 may be partially opened, and when the interior is partially opened, the battery 520 may be loaded into the inside of the supply body 510 or may be taken out.

The battery 520 may supply power to the propeller part 200 to drive the propeller part 200. The battery 520 may be loaded and mounted in the supply body 510, and may be taken out for charging. For example, the battery 520 may be a lithium ion battery.

The display 530 may display a charged state of the battery 520. For example, when the battery 520 needs to be charged, the display 530 may display a red color or a text indicating that the battery needs to be charged. The display 530 may be located on one surface of the supply body 510.

The button 540 may be pressed to drive the propeller part 200 to lift the support part 100. When the button 540 is pressed, power may be supplied to the propeller part 200 from the battery 520, and the propeller part 200 is driven. In addition, while power from the battery 520 is being supplied, the button 540 may be pressed to cut off the power supply from the battery 520. The button 540 may be located on one surface of the supply body 510.

The control unit 600 may receive a measurement signal for the tilting state of the support part 100 generated from the tilt detector 140. In addition, the control unit 600 may perform horizontal level maintenance control so that the patient seating surface 120 of the support part 100 is kept perpendicular to the direction of gravity based on the received measurement signal from the tilt detector 140.

Specifically, the control unit 600 may receive information about the tilting of the support part 100 from the tilt detector 140 to perform the horizontal level maintenance control. In addition, the control unit 600 may control the driving of the propeller part 200. When it is determined that one side of the support part 100 is inclined, the control unit 600 increases or decreases the rotation of the propeller part 200 disposed close to the one side, thereby maintaining the horizontal level of the support part 100.

The control unit 600 may be located inside the power supply unit 500, and may be implemented by a computing device including a microprocessor, a measuring device such as a sensor, and a memory, or a combination thereof. The implementation method is obvious to those skilled in the art, and further detailed description will be omitted.

Hereinafter, the operation and effect of the patient transfer device 1 having the configuration as described above will be described.

Referring to FIG. 5, a user may use the patient transfer device 1 to rescue an emergency patient. After transferring the patient transfer device 1 to an accident place, the user may lay or seat the patient on the support part 100. When the patient is supported by the support part 100, the belt 130 may be worn on the patient to prevent the patient from falling out of the support part 100. When the patient is fixed to the support part 100, the user may press the button 540 to operate the propeller part 200. When the propeller part 200 is operated, the support part 100 and the patient may be lifted. When the support part 100 is lifted, the user may move toward an ambulance, and the support part 100 may move along the user through the connection member 300.

Hereinafter, a process in which the propeller part 200 is unfolded by rotation of the folding part 400 will be described with reference to FIGS. 3A to 3D. When the patient transfer device 1 is not in use, the propeller part 200 may be folded toward the support part 100 to minimize the volume thereof, as shown in FIG. 3A. Then, when it is necessary to drive the propeller part 200 to lift the support part 100, the folding part 400 may rotate with respect to the support part 100 so that the propeller part 200 faces the ground as shown in FIG. 3B. Further, as shown in FIG. 3C, the folding part 400 may rotate with respect to the support part 100 in a direction in which the plurality of propeller parts 200 are away from each other. After the folding part 400 rotates with respect to the support part 100, the plurality of propeller parts 200 may rotate with respect to the folding part 400 so as to be parallel to the ground, as shown in FIG. 3D.

The patient transfer device 1 has an effect that one person can transfer a patient who weighs a lot without mobilizing a plurality of persons. In addition, the user can quickly transfer the patient to an ambulance from the accident place that the ambulance cannot reach.

Meanwhile, beside the above configuration, according to another embodiment of the present disclosure, the control unit 600 may control the propeller part 200 so that the support part 100 follows a rescue worker. Hereinafter, another embodiment of the present disclosure will be described with reference to FIG. 6. In describing another embodiment, differences from the above-described embodiment will be mainly described, and the same configurations as those in the above-described embodiment are given the same reference numerals and the descriptions in the above embodiment are referred.

The patient transfer device 1 may further include a tracking signal generator 700. The tracking signal generator 700 may be provided to any one of a rescue worker and the power supply unit 500, and may be transferred along the movement of any one of the rescue worker and the power supply unit 500 borne by the rescue worker. Further, the movement of the tracking signal generator 700 may be detected by a sensor unit 110. Various well-known sensors may be used as the sensor unit 110 for detecting the movement of the tracking signal generator 700.

The sensor unit 110 may detect the movement of the tracking signal generator 700. For example, various well-known sensors such as an infrared sensor, a temperature sensor, or a distance sensor may be used as the sensor unit 110. The sensor unit 110 may detect the movement of the tracking signal generator 700 when the rescue worker moves to transfer the patient, and may generate a movement signal and transmit the movement signal to the control unit 600.

The control unit 600 may control the driving of the propeller part 200 so that the support part 100 follows the tracking signal generator 700 based on the movement signal generated by the sensor unit 110. The control unit 600 may detect the movement of the tracking signal generator 700 when the rescue worker moves. In addition, the control unit 600 may control the driving of the propeller part 200 so that the support part 100 supporting the patient follows the tracking signal generator 700.

When the tracking signal generator 700 switches the movement direction thereof to the left or the right while moving, the control unit 600 may control the driving of the propeller part 200 to move the patient transfer device 1 to the left or the right along the tracking signal generator 700 after moving forward by a predetermined distance.

In addition, when the tracking signal generator 700 switches the movement direction thereof upward or downward while moving, the control unit 600 may control the driving of the propeller part 200 to move the patient transfer device 1 upward or downward while maintaining the horizontal level along the tracking signal generator 700 after moving forward by a predetermined distance.

The patient transfer device 1 according to the second embodiment may have the effect of being able to follow the rescue worker even when the rescue worker moves or changes the movement direction while moving.

The examples of the present disclosure have been described above as specific embodiments, but these are only examples, and the present disclosure is not limited thereto, and should be construed as having the widest scope according to the technical spirit disclosed in the present specification. A person skilled in the art may combine/substitute the disclosed embodiments to implement a pattern of a shape that is not disclosed, but it also does not depart from the scope of the present disclosure. In addition, those skilled in the art can easily change or modify the disclosed embodiments based on the present specification, and it is clear that such changes or modifications also belong to the scope of the present disclosure.

What is claimed is:

1. A patient transfer device comprising:
a support part including a patient seating surface on which a patient is supported;
a plurality of propeller parts, connected to the support part, for moving the support part;
a power supply unit to be transported while being borne by the user, the power supply unit serving to supply power to the plurality of propeller parts; and
a connection member connecting the power supply unit and the support part,
wherein the support part is configured to move to follow the power supply unit.

2. The patient transfer device of claim 1, further comprising:
a plurality of folding parts each of which has one end rotatably connected to each of the propeller parts, and the other end rotatably connected to the support part,
wherein the folding parts rotate relative to the support part to fold the plurality of propeller parts toward the support part.

3. The patient transfer device of claim 1, wherein the plurality of propeller parts is supported by the support part such that one of the plurality of propeller parts is symmetrical with another one of the plurality of propeller parts with respect to a center of the support part.

4. The patient transfer device of claim 1, further comprising:
a control unit configured to control driving of the plurality of propeller parts; and
a tilt detector which detects tilting of the support part, generates tilting information, and transmits the tilting information to the control unit,
wherein when one side of the support part is tilted, based on the tilting information, the control unit performs a horizontal level maintenance control by controlling a rotation of the propeller part disposed closest to the one side of the support part among the plurality of propeller parts so that the patient seating surface of the support part is perpendicular to a direction of gravity.

5. The patient transfer device of claim 1, further comprising:
a tracking signal generator which generates a tracking signal; and
a control unit configured to control driving of the plurality of propeller parts,
wherein the support part includes a sensor unit which generates a moving signal by detecting the tracking signal generated by the tracking signal generator, and the control unit controls the driving of the plurality of propeller parts so that the support part moves toward the tracking signal generator based on the moving signal generated by the sensor unit.

6. The patient transfer device of claim 5, wherein when a position of the tracking signal generated from the tracking signal generator changes in a left or right direction, the control unit controls the driving of the plurality of propeller parts so that the support part moves in the left or right direction along the tracking signal after moving a predetermined distance.

7. The patient transfer device of claim 5, wherein when a position of the tracking signal generated from the tracking signal generator changes in an upward or downward direction while moving, the control unit controls the driving of the plurality of propeller parts so that the support part moves upward or downward along the tracking signal while maintaining a horizontal level after moving a predetermined distance.

8. The patient transfer device of claim 5, wherein the tracking signal generator is provided in one of the user and the power supply unit borne by the user.
